(19) United States
(12) Patent Application Publication
(10) Pub. No.: US 2008/0155008 A1
(43) Pub. Date: Jun. 26, 2008

(54) Track sort and select system

(75) Inventors: Peter N. Stiles, Owego, NY (US); Shannon M. Beckwith, Endicott, NY (US); David Brown, Endicott, NY (US); Christine M. Collins, Owego, NY (US); Joan M. Hendy-Kline, Waverly, NY (US); Robert L. Kilmer, Endicott, NY (US); Erica H. Miles, Dryden, NY (US); James L. Moniz, Vestal, NY (US); Daniel H. Neuburger, Endicott, NY (US)

Correspondence Address: Lockheed Martin Corporation;c/o WOLF, GREENFIELD & SACKS, P.C., 600 ATLANTIC AVENUE, BOSTON, MA, 02210-2206, US

(73) Assignee: Lockheed Martin Corporation, Bethesda, MD (US)

(21) Appl. No.: 11/800,817

(22) Filed: May 8, 2007

Related U.S. Application Data
(60) Provisional application No. 60/799,060, filed on May 9, 2006.

(51) Int. Cl. G06F 15/16; G06F 3/048; G06F 17/30

(52) U.S. Cl. 709/201; 715/810; 715/771; 707/5; 707/E17.014

(57) ABSTRACT

Embodiments of the invention relate to systems and methods for processing tactical data to identify or display more useful portions of such data and/or to suppress or hide less useful portions of such data. One application for these systems and methods is processing tactical data received from a tactical data link. For example, the systems and methods may be applied to a tabular display or tactical plot that displays information pertaining to tactical entities.

### RELATED APPLICATIONS

This application claims priority under 35 U.S.C. §119 to U.S. provisional application Ser. No. 60/799,060, filed May 9, 2006, which is hereby incorporated by reference in its entirety.

### GOVERNMENT SUPPORT

Aspects of this invention were made with United States Government support under contract number N00019-03-G-0014-0009 with the Department of the Navy. The United States Government may have certain rights in the invention.

### FIELD OF THE INVENTION

This application relates to systems and methods for processing tactical data.

### BACKGROUND OF THE INVENTION

Military cockpits can receive tactical data from multiple sensors and communications links. The tactical data provides important information about entities in the tactical battlespace, called “tracks.” A track may be, for example, a ship, aircraft, submarine, land vehicle, rendezvous point, flight corridor, no-fly zone, danger area, emergency point, distressed vehicle, deployed sensor, sensor contact, weapon location, target location, or friendly attacker. The number of tracks received by a military cockpit may be so overwhelming that pilots and aircrews cannot easily distinguish important information from unimportant information. This results in a lack of situational awareness, which can result in failed missions and danger to the pilots and aircrew.

Newer cockpit systems (and command centers) generally incorporate some functions to filter or highlight received tactical information, but these functions are inadequate. The inadequacy of such functions has become heightened as the amount of track data received by military cockpits has increased. The problem is particularly acute for smaller tactical aircraft that cannot afford to have one or more crewmembers dedicated to the full-time job of managing track data.

### SUMMARY OF THE INVENTION

Embodiments of the invention relate to systems and methods for processing tactical data to identify or display more useful portions of such data and/or to suppress or hide less useful portions of such data. One application for these systems and methods is processing tactical data received from the Link 16 tactical data link, although the invention is not so limited.

One embodiment of the invention is directed to a method for processing tactical data comprising at least partially displaying a table comprising a list of tactical entities and respective attributes of said entities, inputting information supplied by an operator concerning at least one of the attributes, and reordering the list based on the operator-supplied information.

Another embodiment of the invention is directed to a method for processing tactical data comprising providing a database of tactical entities and respective attributes of said entities, inputting information supplied by an operator concerning at least one selected attribute, displaying, on a tactical plot, a representation of an entity in the database, and when said entity has the at least one selected attribute, providing an alert to the operator.

A further embodiment of the invention is directed to a method for processing tactical data comprising providing a database of tactical entities and respective attributes of said entities; inputting first information supplied by an operator specifying at least one criterion of at least one first selected attribute, the first information defining information of interest to the operator; inputting second information supplied by an operator specifying at least one criterion of at least one second selected attribute, the second information defining information of lesser interest to the operator; processing the database of entities based on the first information and the second information to identify a sub-group of the entities wherein none of the entities included in the sub-group has the at least one criterion of the at least one second selected attribute unless said entity also has the at least one criterion of the at least one first selected attribute; and displaying to the operator information pertaining only to entities within the sub-group.

Another embodiment of the invention is directed to a system for processing tactical data, comprising at least one display, at least one operator interface, at least one processor, and at least one computer readable medium. The computer readable medium is encoded with instructions that, when executed by the at least one processor, perform a method comprising (A) at least partially displaying a table on the at least one display, wherein the table comprises a list of tactical entities and respective attributes of said entities, (B) inputting information supplied by an operator via the at least one operator interface, wherein the operator-supplied information concerns at least one of the attributes, and (C) reordering the list based on the operator-supplied information.

### BRIEF DESCRIPTION OF THE DRAWINGS

FIG. 1 shows an overview of how data is processed after being received by a Multifunctional Information Distribution System (MIDS) terminal of a Multi-Mission Helicopter (MMH);

FIG. 2 shows an exemplary implementation of a key interface used in connection with the Track Sort & Select (TSS) application, wherein the key interface comprises a set of keys referred to as the “database control layer”;

FIG. 3 shows an example of a TSS table;

FIG. 4 shows the key interface comprising another set of keys referred to as the “TSS table key layer”;

FIG. 5 shows an exemplary query window format that may be used for attributes having numeric values;

FIGS. 6a and 6b show exemplary query window formats that may be used for attributes having text values;

FIGS. 7-12 show an example of how the TSS application capabilities can be used by an operator to quickly locate a replenishment point near the operator's helicopter;

FIG. 13 shows keys of the database control layer that may be used in connection with the reports of interest (ROI) capability of the TSS application;

FIG. 14 shows an exemplary configuration of the reports of interest definition window;

FIG. 15 shows keys of the key interface that may be used in connection with the reports of interest (ROI) definition window;

FIGS. 16-27 show an example of how the TSS application capabilities can be used by an operator to remove extraneous tracks from data of interest;

FIG. 28 shows an exemplary configuration of consecutive horizontal pages of a displayed TSS table; and

FIG. 29 shows an exemplary system for implementing methods described herein.

### DETAILED DESCRIPTION OF THE INVENTION

As discussed above, the amount of tracks received by military cockpits can be so overwhelming that it is difficult to discern important information. Accordingly, there is a need to process tracks in a manner that makes discerning important information easier for the operator.

In view of the foregoing, aspects of the invention relate to a system that integrates track management and database tools into an informational system of a cockpit. These tools allow operators to recognize important information and suppress unimportant (or less important) information so that situational awareness can be maintained. Further, the tools allow the track information to be managed in a simple manner, such that piloting and mission management tasks are not compromised. The efficiency of the tools also allows the size of some aircrews to be reduced because less time needs to be spent reviewing track information.

The track management and database tools described herein may provide at least three basic functional capabilities. These capabilities are (1) the “find” capability, (2) the “filter” capability, and (3) the “Reports of Interest (ROI)” capability. Each of these functional capabilities is summarized below and discussed in more detail in connection with the attached figures.

The “Find” Capability

The “find” capability allows operators to find and review tracks of interest using simple queries. For example, using the find capability, an operator can quickly locate a nearby replenishment point. To do so, the operator may first find all tracks that are identified as replenishment points, and then sort the narrowed results by distance. As another example, the find capability may allow an operator to quickly locate all friendly aircraft carriers in the vicinity. The operator can identify tracks matching these criteria by first finding all tracks identified as friendly, next finding those friendly tracks that are also aircraft carriers, and then sorting the narrowed results by distance.

The “Filter” Capability

The “filter” capability allows operators to remove unimportant information from further processing by the rest of the system. An operator may define a filter using a specific set of attributes, and activate the filter as desired. Such a filter may be useful because it can prevent large numbers of tracks (e.g., hundreds) that do not affect a mission from being processed. For example, using the filter capability, an operator can configure the cockpit informational system to not process “unknown” land tracks sent out by a particular surveillance aircraft.

The “Reports of Interest (ROI)” Capability

The “Reports of Interest” (ROI) capability allows an operator to define rules that enable important information to pass through the filters that are established using the filter capability. For example, using the ROI capability, an operator can permit unknown land tracks within 30 miles to be processed, even though those tracks would have been otherwise filtered. Optionally, the ROI capability may also be used to generate special alerts concerning tracks that satisfy the defined rules. For example, using this capability, an operator may request that an alert be generated in the event that a certain type of ship (e.g. a Kirov-class battlecruiser) is reported.

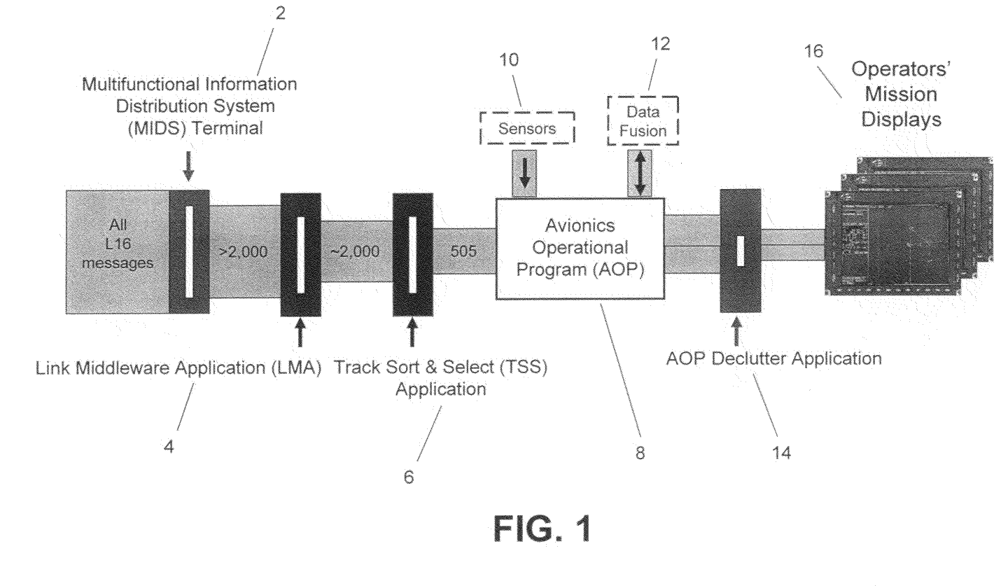

A system that provides these capabilities, and methods of using the system, are described below in connection with FIGS. 1-28. It should be appreciated that while the examples provided herein are in the context of a track processing system located in the cockpit of a helicopter, the invention is not so limited. Rather, the system and methods described herein may be used in many other contexts, including in the track processing system of a ship, submarine, tank, airplane, or other transportation vehicle. Further, the system and methods need not reside in a vehicle at all. The system and methods may be incorporated into a stand-alone unit that may interface with an existing track processing system or be self-contained. Such a unit may be used by soldier in combat to improve situational awareness.

FIG. 1 shows an overview of how data is processed after being received by a Multifunctional Information Distribution System (MIDS) terminal 2 of a Multi-Mission Helicopter (MMH). A MIDS terminal 2 is a unit that allows “Link 16” tactical data to be transmitted and received. Link 16 is a data link used by U.S. and foreign militaries so that aircrafts, ships, tanks, and other entities can exchange tactical information in real time. The tactical information may comprise RADAR data, images, sensor data, voice messages, etc.

The MIDS terminal 2 receives all incoming Link 16 messages. Certain non-track messages that do not pertain to the MMH, such as controlling unit change messages, will be dropped. All remaining incoming messages are passed to a Link Middleware Application (LMA) 4 for processing.

The LMA 4 handles the accounting for track numbers (TNs), which are assigned to and uniquely identify Link 16 tracks. The LMA 4 also applies geographical filters, such as circular filters, to eliminate tracks that are not within the vicinity of the MMH (which is also referred to as “ownhelo” for “own helicopter”). Remaining tracks are passed to the Track Sort & Select Application (TSS) 6.

The TSS application 6 is an application that provides, among other things, the find, filter, and ROI capabilities described above. As will be described in detail herein, the TSS application 6 accepts operator inputs to process (e.g., “mine”) data, and thereby allows the operator to quickly identify information of interest. Tracks remaining after processing by the TSS application 6 are passed to the Avionics Operational Program (AOP) 8 for track management. If the number of tracks remaining after processing exceeds system capacity (e.g., 505), the tracks may be further processed based on pre-defined parameters, such as type or distance, until the number of tracks is within the system capacity.

The AOP 8 integrates the subsystems on the MMH to perform mission application, flight control, and ground based diagnostics & maintenance of the helicopter. The AOP 8 receives data from sensors 10 (e.g., navigational Radio Detection And Ranging (RADAR) and Identify Friend or Foe (IFF) data systems) and integrates data from different sources for a single track using data fusion capabilities 12.

Data is then passed to an AOP Declutter application 14. The AOP Declutter application 14 allows an operator to control symbols that are shown on the tactical plot displayed on the operators' mission displays 16. Displayed symbols represent tracks, and have attributes indicative of certain characteristics of the track (e.g., the type of track, where it is located, and whether it is friendly). If only certain symbols are of interest, other symbols can be filtered by the AOP Declutter application 14 so that they are not displayed.

If desired, the TSS application 6 and/or the AOP Declutter application 14 can be programmed to always pass certain types of tracks. For example, the TSS application 6 may be programmed to always pass emergency point tracks to the AOP Declutter application 14, and the AOP Declutter application 16 can be programmed to always display such points.

According to one aspect of the invention, the system is configured to allow an operator to use the capabilities provided by the TSS application 6 while alternately displaying on the mission displays the tactical plot mentioned above and a tabular data display. Each of these displays offers particular advantages. For example, the tactical plot allows for the visualization of data in a geographic setting, whereas the tabular data display allows visualization of large amounts of information relating to various aspects of the tracks.

Although FIG. 1 shows the TSS application 6 in the context of Link 16 data flow, it should be appreciated that Link 16 is just one exemplary data link with which the systems and methods of the invention may be used. The systems and methods described may be adapted for use with other tactical data links, including those already and not yet developed.

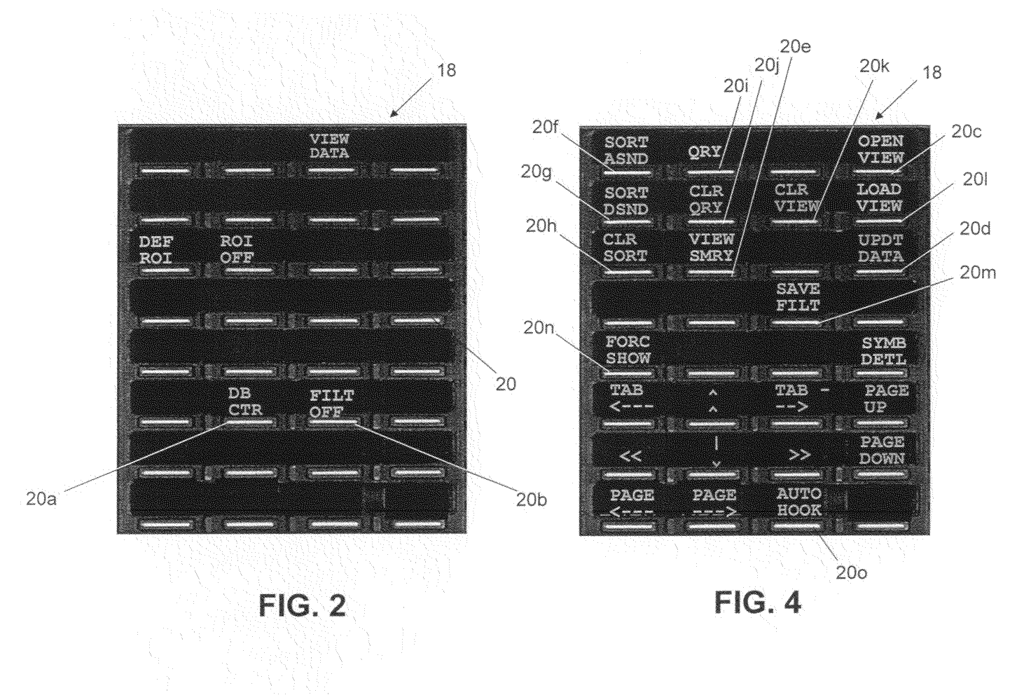

The TSS application 6 may be encoded on a one or more computer-readable media, which are operatively coupled to a processor. As explained above, one or more displays may be provided to allow outputs of the TSS application to be visualized. In addition, one or more input devices may be provided. The input device or devices may be part of the display itself (e.g., a touch screen) or may be separate. According to one exemplary implementation shown in FIG. 2, the TSS application 6 of FIG. 1 accepts operator inputs via a key interface 18. In the example shown, the key interface 18 comprises thirty-two programmable keys 20, each of which is associated with a light emitting diode (LED) display identifying the function of the key. Other types of displays and switches may alternatively be used. For example the displays may alternatively be implemented with liquid crystal displays, and the switches may be implemented as knobs. If an integrated switch/display mechanism is desired, a touch screen may be used to provide both the display and switch function.

The key interface 18 may be manipulated by an operator to display particular keys or key sets of interest. In FIG. 2, the set of keys shown is referred to as the “database control layer.” The displayed keys 20 may be activated to perform various functions as will be described in detail herein. For example, a database control or “DB CTR” key 20a is provided to switch an associated display between the tactical plot or “geosit” and the tabular data display, also called the “TSS table.” In the example provided, switching between the two modes of display is required because there are not enough displays in the cockpit to separately display both the tactical plot and the TSS table. However, in other environments, the tactical plot and the TSS table may be simultaneously displayed such that this function is not required.

As another example, a filter or “FILT” key 20b is provided to turn data filters on or off. As discussed above, data filters are a capability of the TSS application that allows operators to remove unimportant information (i.e., tracks) from further processing. Examples of such data filters will be provided herein.

The initial state of the filter key may be set by the Mission Planning System (MPS), which has a provision to define the initial data load for the aircraft. To switch between settings, the filter key may be repeatedly depressed in round-robin fashion until the desired option, such as “filter off” in the example of FIG. 2, is found. After a predetermined settle time after a final depression, the system will assume the selected state. If desired, activating the filter key in a manner that will change the filter setting can trigger an “Are You Sure?” (AYS) prompt, to get operator confirmation that the action is desired before the filter setting is changed.

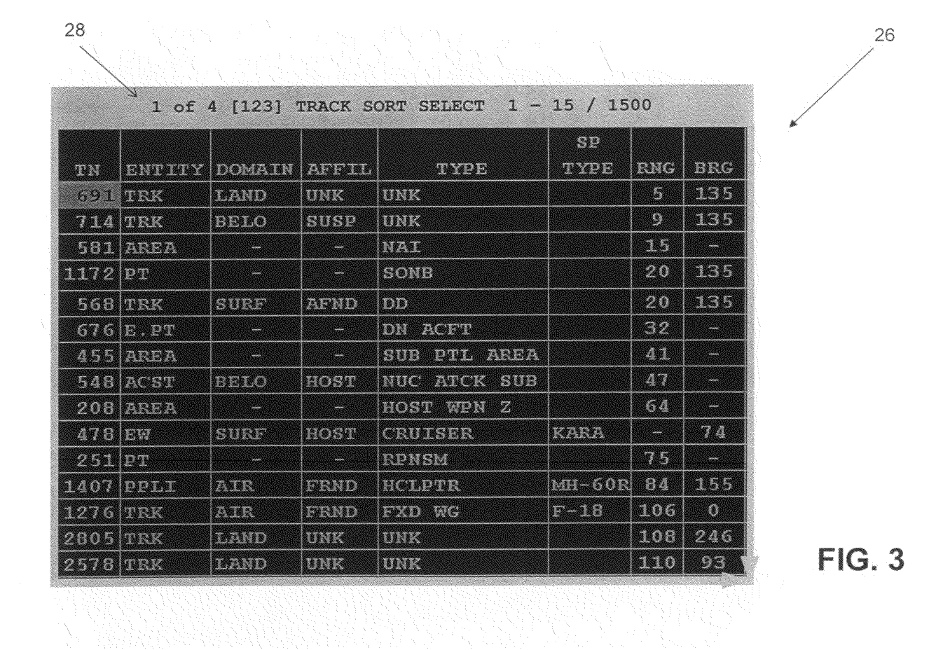

FIG. 3 shows an example of a TSS table 26, as described above. The table 26 includes information for tracks received from the LMA 4 (FIG. 1). The displayed table 26 shows only a portion of all tracks and a portion of the data for such tracks. Accordingly, the screen may be controlled to show rows below and columns to the right of those currently shown. As the header 28 of the table 26 indicates, in the screen view of FIG. 3, one of four horizontal pages are displayed and fifteen of fifteen hundred total rows are displayed. Because of the large number of tracks and the small area available for display, the utility of the TSS capabilities may readily be appreciated. In particular, as will be described, the TSS application allows tracks of importance to be moved to the top of the table based on criteria inputted by an operator.

The columns displayed in the portion of the table 26 visible in FIG. 3 respectively show (if known) for each track: the track number (TN); entity type of the track (e.g., a moveable entity, referred to as a “track” in the table, a point, an area, a Precise Participant Location and Identification (PPLI)); the domain of the track (e.g., air, land, water surface, below water); the affiliation of the track (e.g., unknown, suspect, hostile, assumed hostile, friend); the general type of the track (e.g., unknown, cruiser, nuclear attack submarine, helicopter, hostile weapon zone); the specific type of the track (e.g., an F-18 or an MH-60R); the range of the track (e.g., 20 miles); and the bearing of the track (e.g., 135 degrees). For example, refer to the track uniquely identified in the table of FIG. 3 with track number “1276.” As shown in the table 26, this track is a movable entity (or “track”), and specifically is an F-18 fixed wing airplane. The airplane is friendly, and is 106 miles away in the air, at a bearing of zero degrees.

FIG. 4 shows another set of keys that may be displayed on key interface 18. The set of keys is referred to as the “TSS table key layer” and comprises keys used to control aspects of the TSS table 26 described in connection with FIG. 3. As discussed in connection with FIG. 2, when the database control key is pressed, the operator display switches between the tactical plot or “geosit” and the TSS table. If the display is thus switched to the TSS table, the key layout of the database control layer also changes from the layout shown in FIG. 2 to the layout shown in FIG. 4. The function of several of the keys shown in FIG. 4 are described below.

The “OPEN VIEW” key 20c opens a window allowing an operator to select one of the current filter definitions (e.g., A, B, C or D), to populate the data window with its set of queries. Selecting one of the current filter definitions may clear out any existing sorts or queries. The “UPDT DATA” key 20d refreshes the data and re-applies all current sorts and queries. The “VIEW SMRY” 20e key opens a window that lists the current sorts & queries in order, in text format. The “CLR LINE” key (not shown) can then be used to delete a single sort or query, and the “CLR MENU” key (also not shown) can be used to delete all sorts and queries. The “SORT ASND” and “SORT DSND” keys 20f, 20g sort a column in ascending or descending order. The “CLR SORT” key 20h removes a sort for that column. The “QYR” key 20i opens an appropriate query window. The “CLR QYR” key 20j clears a query for that column. The “CLR VIEW” key 20k removes all of the queries and sorts from the data table. The “LOAD VIEW” key 201 opens a window allowing operator to select one of the original four MPS filter definitions (e.g., A, B, C or D), to populate the data window with its set of queries. The window has additional menu option to allow an operator to apply the filter at the same time. The “SAVE FILT” key 20m opens a window allowing operator to save the current set of queries to one of the four filters. The window has additional menu option to allow an operator to apply the filter at the same time. This option defaults to last filter opened or loaded. The “FORC SHOW” key 20n toggles the Force Show state for the currently selected item. If Force Show is on, that item will be forced through all filters. The “AUTO HOOK” key 20o closes the TSS table and returns to the tactical display or “geosit” with the currently selected item hook-selected and centered on-screen.

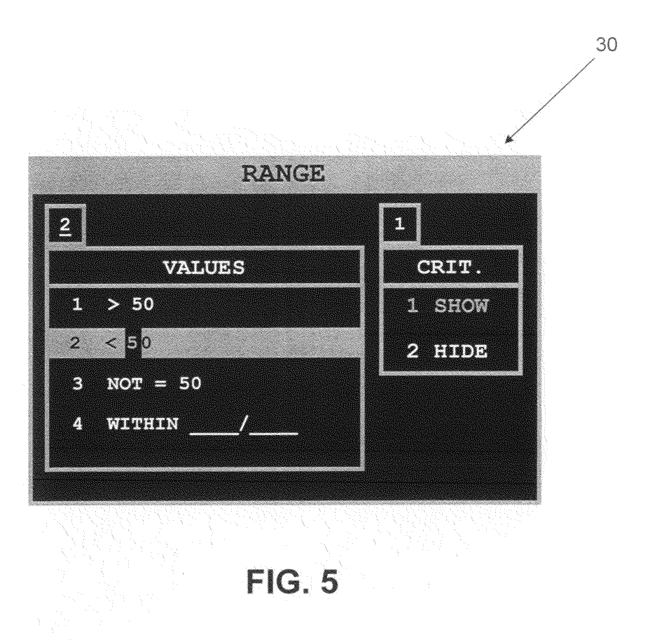

As discussed above, the “QRY” key 20i opens an appropriate query window. FIG. 5 shows such a query window 30, and provides an example of how a query is performed. In the example, a query is performed with respect to the range attribute shown in the TSS table of FIG. 3. When the arrow keys of the TSS table key layer (FIG. 4) have been used to highlight an entry in the range column of the TSS table, the QRY key may be pressed to initiate a query on this attribute. After pressing the QRY key, the range query window is displayed over a portion of the TSS table. The query window includes two sub-windows, a “values” sub-window and a “criteria” sub-window. First, a value category in the values sub-window is selected and numbers may need to be entered (e.g., in the case of selection 4). Next, either the “show” criterion is selected in the criteria sub-window so that all tracks with the selected category of values are moved to the top portion of the TSS Table, or the “hide” criterion is selected so that all tracks with the selected category of values are moved to the bottom portion of the table. Although hidden tracks are displayed (in “ghosted” text) in the TSS table, they are not displayed in the tactical plot. Further, hidden tracks are not processed by the AOP Declutter application described in connection with FIG. 1.

In the example shown, the value category of “less than 50” has been selected in the values sub-window of the range query window, and the “show” criterion has been selected in the criteria sub-window. Accordingly, tracks having a range of less than 50 miles are moved to the top of the TSS table. This is an example of using the “find” capability of the TSS application.

The query window format of FIG. 5 may be used for other attributes having numeric values (e.g., bearing or range). Thus, queries for other attributes having numeric values may be performed in the same manner as described above.

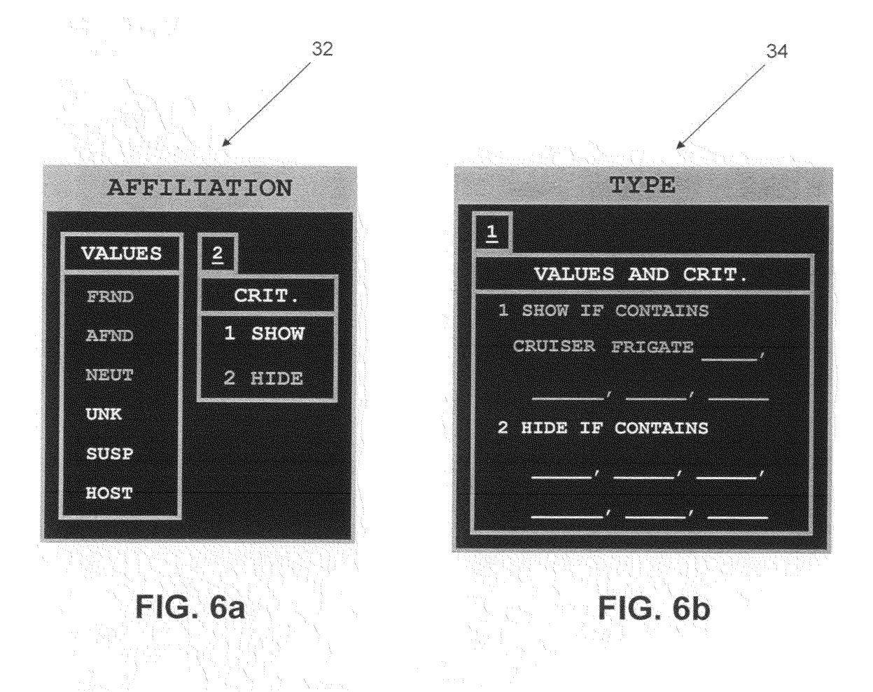

FIGS. 6a and 6b show query window formats that may be used for attributes having text values, and provide examples of how such queries may be performed. These query windows may be opened by highlighting an entry in the column for the corresponding attribute in the TSS table (FIG. 4), and pressing the QRY key.

As a first example, an affiliation query window 32 is shown in FIG. 6a. This window allows an operator to select one or more affiliations in the “values” sub-window, and select whether those values should be shown or hidden in the TSS table in the manner described in connection with FIG. 5. Similar query windows may be used to perform queries for the “entity” and “domain” attributes shown in the TSS table of FIG. 3.

As a second example, a type query window 34 is shown in FIG. 6b. This window allows an operator to select types of tracks to be shown and/or types of tracks to be hidden. In this case, because the number of possible types is so large that all possibilities cannot be practically displayed in the query window, the types to be shown or hidden are be manually entered by the operator (e.g., via a keypad) in either the “show” portion of the window or the “hide” portion of the window. Alternatively, the type query window may have a format similar to that of the affiliation query window, such that types may be manually entered in a values sub-window, and whether the selected values are shown or hidden may be selected using the criteria sub-window. Query windows similar to those described above may be used to perform queries for the “specific type” and “track number” attributes shown in the TSS table of FIG. 3. These attributes likewise tend to have a large number of possible options.

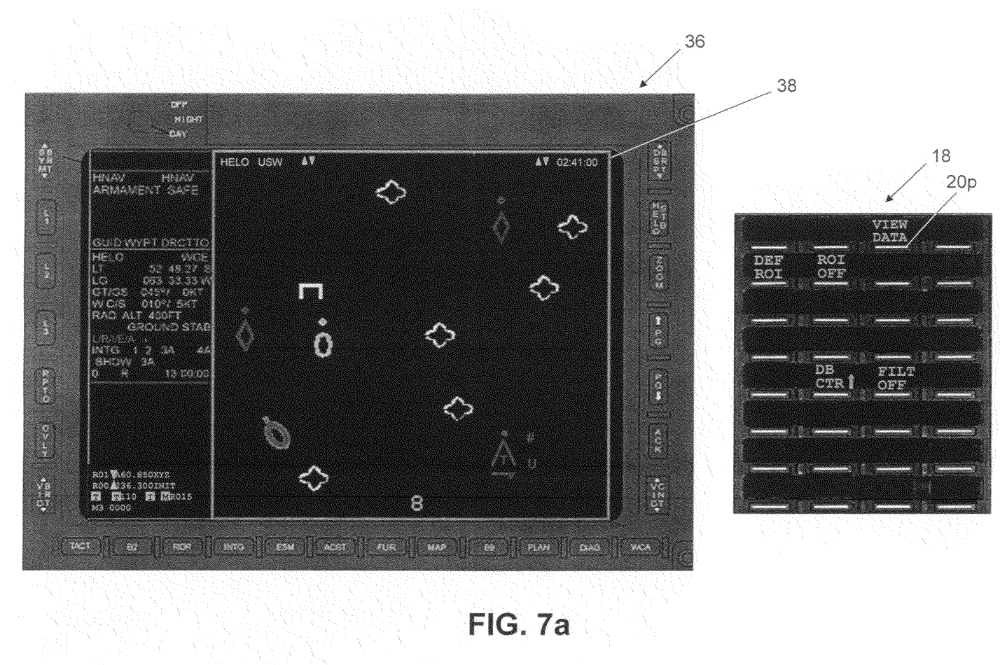

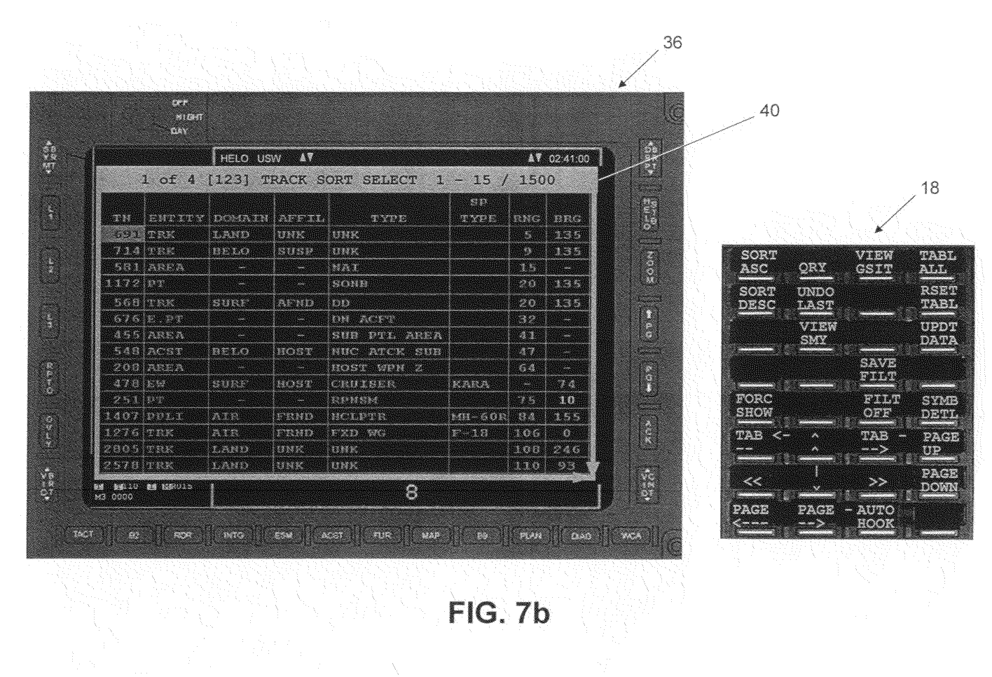

FIGS. 7-12 show an example of how the TSS application capabilities can be used by an operator to quickly locate a replenishment point within 20 miles of the helicopter. Such a task may be useful, for example, when the helicopter is running low on fuel and must identify a nearby location for refueling. The first step in the task, shown in FIGS. 7a and 7b, is to configure the display 36 so that it is showing the TSS table. Initially, as shown in FIG. 7a, the display 36 is showing the tactical plot (geosit) 38. To hide the geosit 38 and show the TSS table, the “VIEW DATA” key 20p may be pressed on the database control layer of the key interface 18. The label of this key changes in a round-robin fashion as the key is depressed. The key 20p may also be activated to view the tactical plot (geosit) (i.e., when the key 20p is labeled “VIEW GSIT”). In FIG. 7b, the TSS table 40 is displayed, and the key interface 18 displays the TSS table key layer.

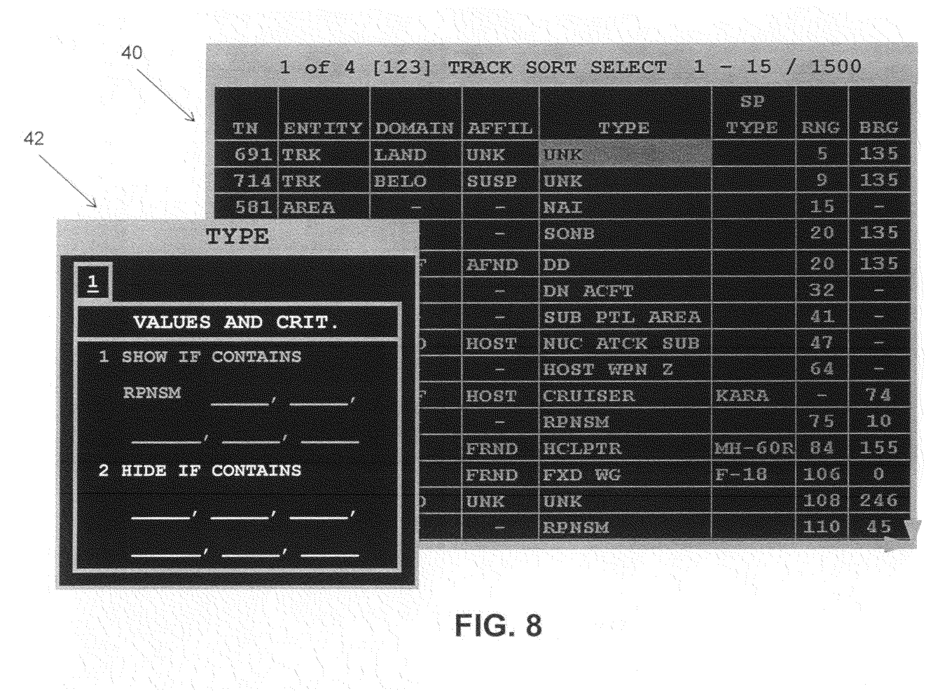

FIG. 8 shows the next steps of the task, which involve using the “find” capability to identify replenishment points. First, using the key interface 19, the operator arrows over to the type column of the TSS table 40 and presses the QRY key 20o on the key interface 18 (FIG. 4) to cause the “type” query window 42 to appear over the TSS table. In the “show” section of the query window 42, the operator fills in “RPSNM” and presses an enter key that appears on the key interface 18 when the query window 42 is open.

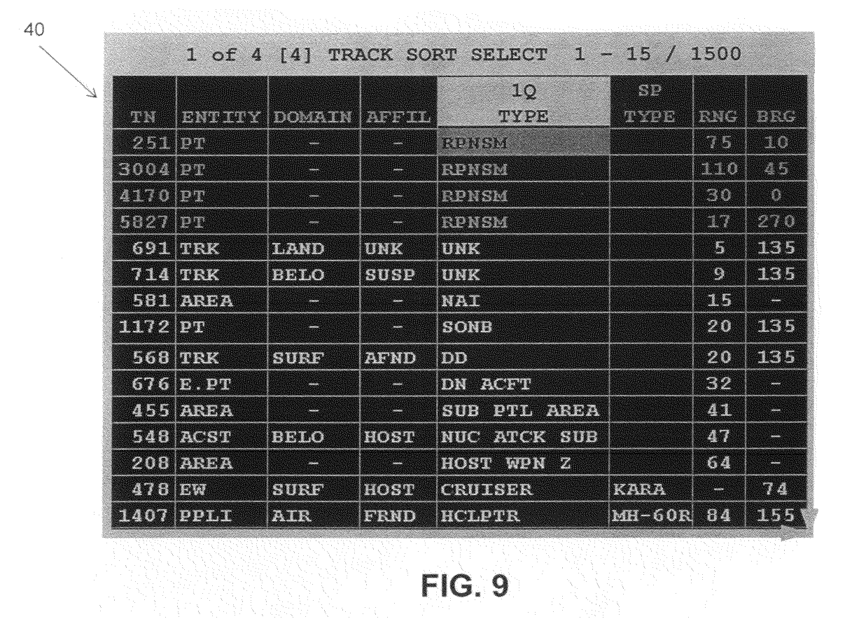

FIG. 9 shows the appearance of the TSS table 40 after the enter key is pressed. Notably, all replenishment tracks have moved to the top of the table, while other tracks are at the bottom of the table and ghosted. The indicator “1Q” is displayed with the type header to indicate that a first query has been performed.

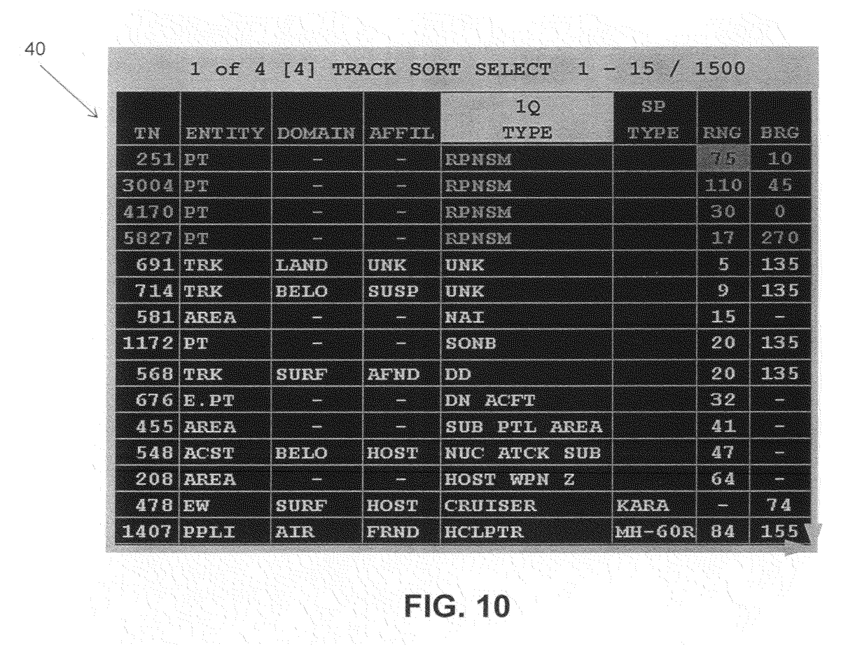

FIG. 10 shows the next steps of the task, which involve using the sort function to identify nearby replenishment points. Using the TSS table key layer, the operator arrows over to the range column of the TSS table 40 and presses the SORT ASND key (FIG. 4) to cause the non-ghosted tracks to be sorted in ascending order (smallest to highest) by range. The ghosted tracks may also be sorted in ascending order by range when the SORT ASND key is pressed, but are sorted separately from the non-ghosted tracks at the top of the table.

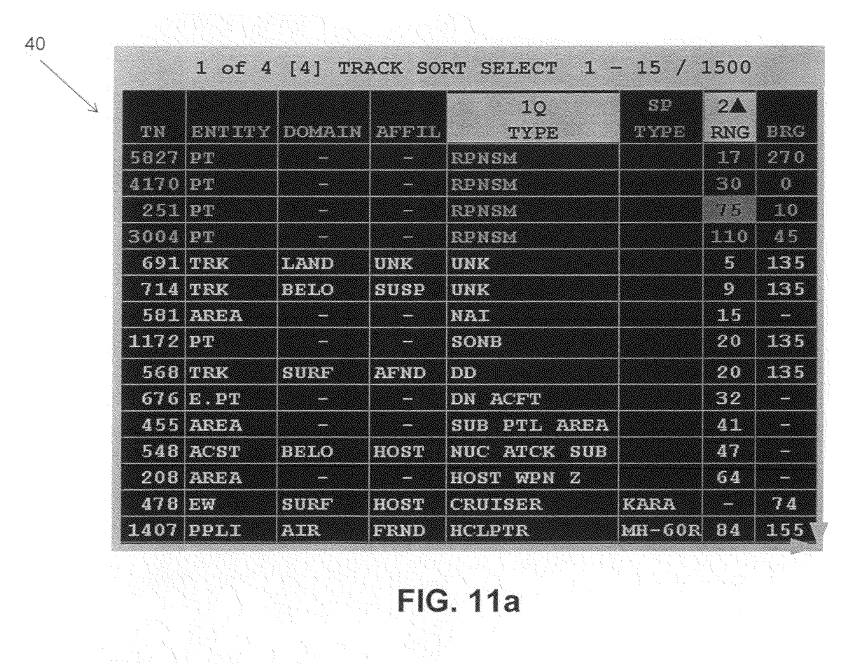

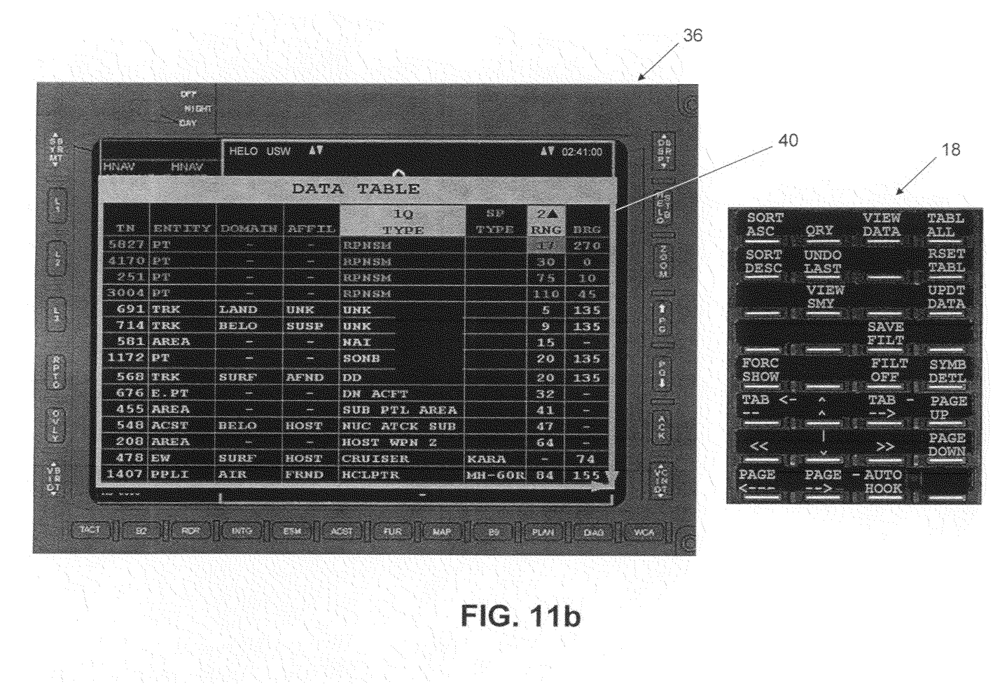

FIG. 11a shows the appearance of the TSS table 40 after the SORT ASND key is pressed. Notably, the replenishment tracks are now listed in ascending order by range, so that the closest replenishment points are displayed first. In addition, the indicator “2A” is displayed with the range header to indicate that a second sort has been performed. The TSS table 40 can now be viewed to quickly locate a replenishment point within 20 miles of the helicopter. The TSS table 40 indicates that there is only one such replenishment point. To locate that point on the tactical plot, the operator can arrow up to the track of interest, as shown in FIG. 11b, and press the AUTO HOOK key on the TSS table key layer (FIG. 4). This causes the TSS table 40 to be suspended, and the tactical plot to be displayed. Further, the tactical plot will be displayed with information on the track of interest (i.e., the “hook”).

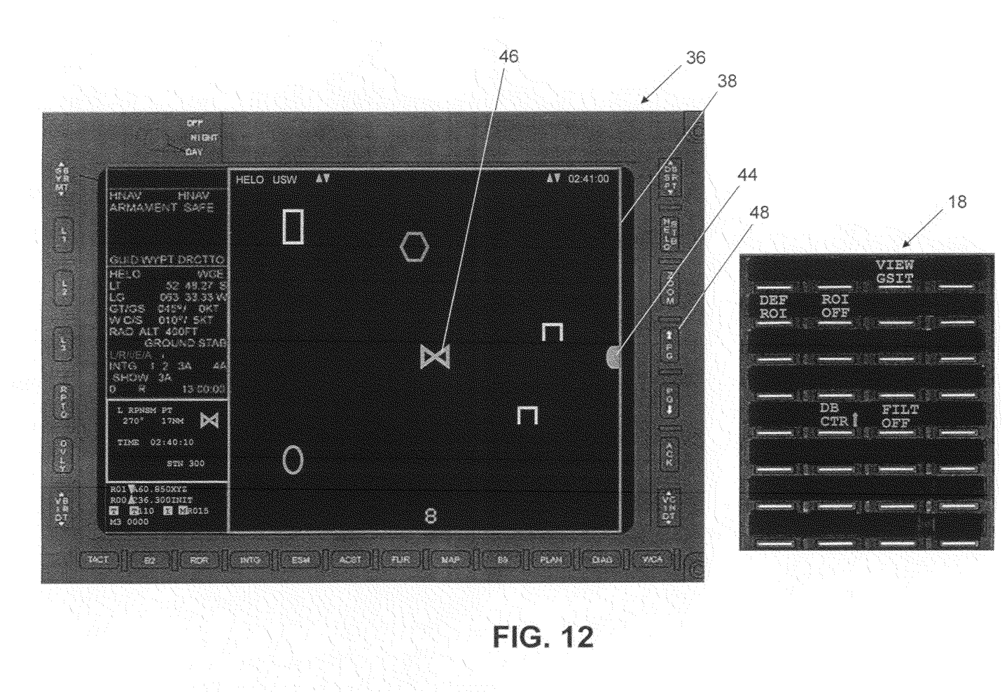

FIG. 12 shows the appearance of the tactical plot 38 after the AUTO HOOK key is pressed. On the left hand portion of the display 36, the hook 46 is identified, along with its bearing, distance, flight time, and identifying symbol. The hook 46 is also shown symbolically on the tactical plot 38. The helicopter (ownhelo) is symbolically shown as the filled partial oval 44 on the far right portion of the tactical plot 38. The displayed area can be manipulated using any of numerous keys provided for this purpose, such as keys 48 on the display 36.

The example of FIGS. 7-12 demonstrates how an operator using a console in a helicopter can quickly identify a resource. While the console of FIGS. 7-12 comprises display 36, additional or alternative equipment may be used to perform the functions described. Further, it should be appreciated that the same principles may be applied for one or more operators using one or more consoles in a vehicle (e.g., an aircraft) or other location within close proximity.

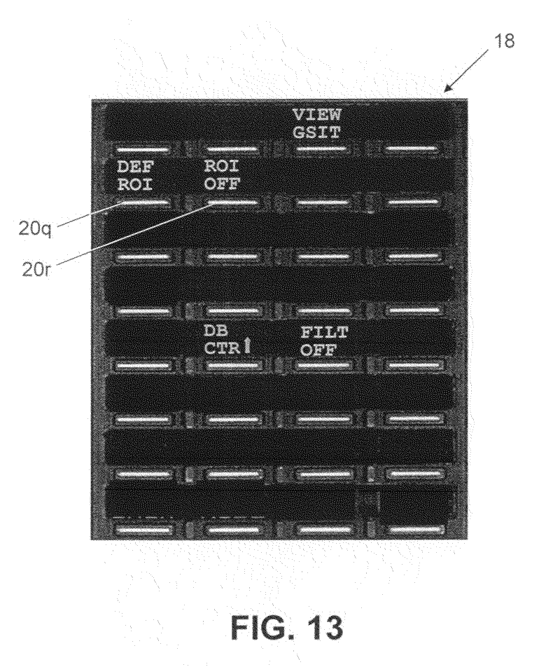

FIG. 13 shows two keys on the database control layer that may be used in connection with the “ROI” capability of the TSS application. In particular, the “DEF ROI” key 20q may be pressed to open a window that allows an operator to define a report of interest. If such a window is already open an another display, a notification may be issued indicating that the function is already in use by another operator. The “ROI OFF/ON” key 20r is a round-robin key that allows the operator to select whether ROI alerts are activated or inactivated. According to one example, an ROI alert causes tracks meeting the ROI criteria to be identified using an annotation (e.g., a bearing line) to the symbol displayed on the tactical plot. However, other methods of alerting the operator may be used, such as a pop up window, an audible alert, a symbol of a particular color, etc.

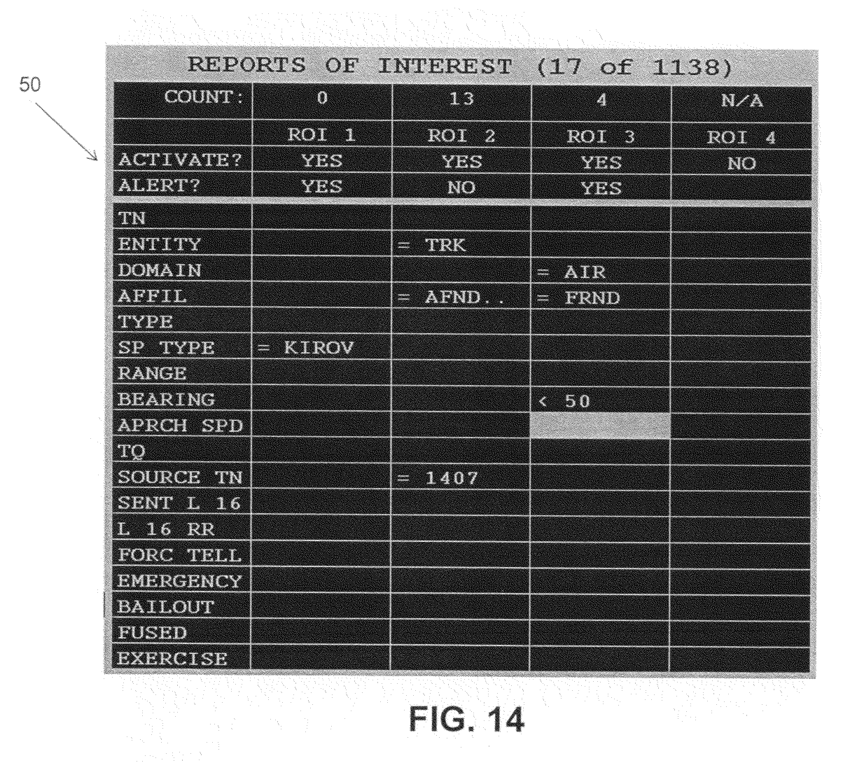

FIG. 14 shows the appearance of the reports of interest definition window 50 that is opened after the “DEF ROI” key is pressed. In the example shown, three defined reports of interest rule sets are displayed. Of these, all are activated, which has the effect of causing the tracks that meet the established criteria to override any filters that may otherwise be established. In other words, the tracks that meet the established criteria will be displayed on the tactical plot and in a non-ghosted fashion in the TSS table, even if a filter is established that would otherwise cause the track to not be displayed on the tactical plot and ghosted on the TSS table. Further, two defined reports of interest (ROI 1 and ROI 3) have activated alerts. Thus, tracks meeting the criteria of ROI 1 or ROI 3 will be identified with an annotation to the symbols displayed on the tactical plot. The “count” row of the reports of interest definition window indicates how many tracks meet the criteria of each defined report of interest.

Several exemplary criteria are listed in the headings of column 1, and for some such criteria, corresponding values have been defined in the reports of interest. For example, ROI 3 is defined such that reports of interest are active and alerts will be generated for friendly, airborne tracks having bearings of less than 50 degrees.

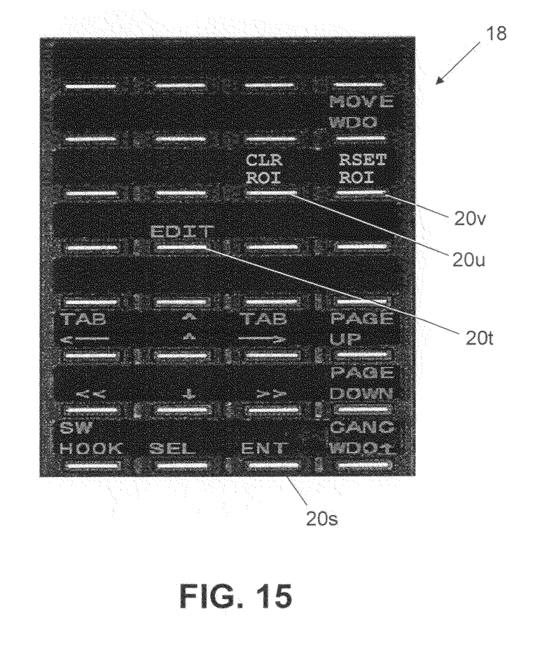

FIG. 15 shows several keys of the key interface 18 that may be used in connection with the reports of interest (ROI) definition window 50 of FIG. 14. This ROI key layer is displayed when the reports of interest definition window 50 is open.

The “EDIT” key 20t may be used to open a secondary window in which the criteria of a report of interest may be edited, the “CLR ROI” key 20u may be used to reset or clear all rules defined for a report of interest, and the “RESET ROI” key 20v may be used to reset the rules defined for a report of interest to default settings. The ROI key layer also includes an enter key 20s, labeled “ENT,” to allow an operator to initiate the processing of entered information, and various arrow and tab keys to allow an operator to move between the rows and columns of the table. The key layers that are displayed when other windows are opened in response to activation of a key on the TSS table key layer may include similar features (e.g., an ENT key and arrow and tab keys).

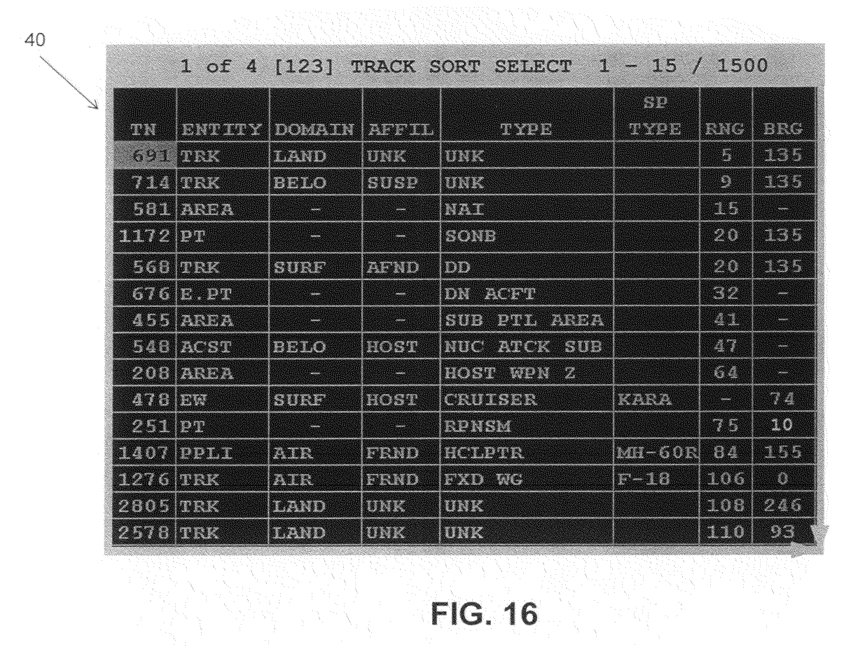

FIGS. 16-27 show an example of how the TSS application capabilities can be used by an operator to remove extraneous tracks from data of interest. These extraneous tracks include Joint Surveillance Target Attack Radar System (JSTARS) transmissions from a particular source (having source track number 500) other than those from land entities, Airborne Warning and Control System (AWACS) transmissions from a particular source (assigned source track number 12222), and all other transmissions from land entities. Such a task may be useful, for example, when a helicopter needs certain land-based JSTARS transmissions for a mission, but is receiving a large number of other land entity transmissions and a large number of air tracks from a particular source AWACS, making important information difficult to discern. The first step in the task, shown in FIG. 16, is to configure the display so that it is showing the TSS table 40 by pressing the “VIEW DATA” key (i.e., key 20p in FIG. 7a).

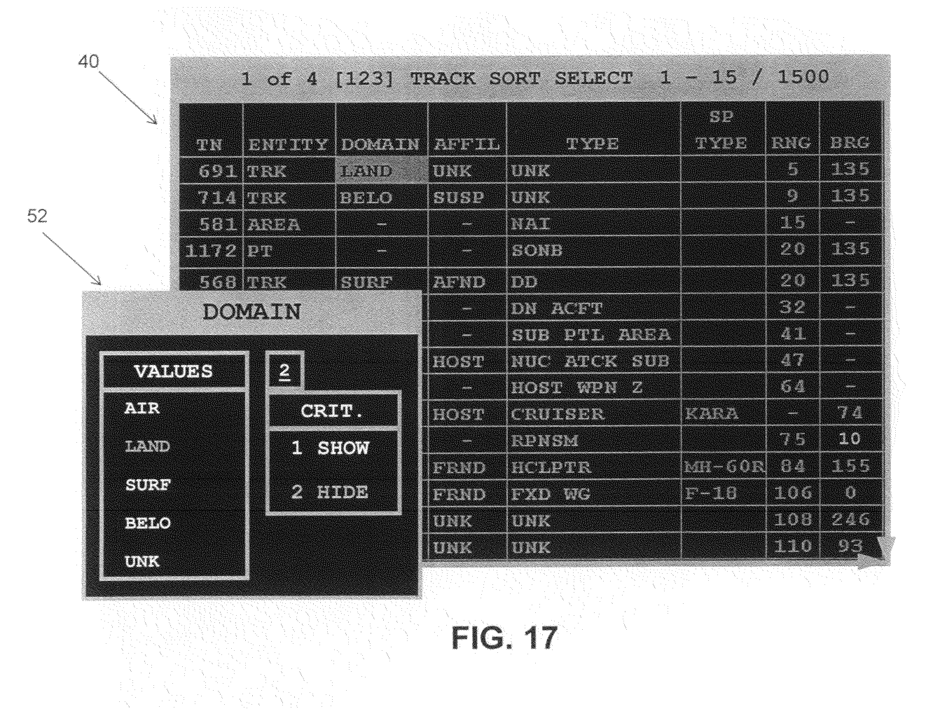

FIG. 17 shows the next steps of the task, which involve using the “filter” capability of the TSS application to hide land entities. First, using the TSS table key layer (FIG. 4), the operator arrows over to the domain column of the TSS table 40 and presses the QRY key to cause the “domain” query window 52 to appear over the TSS table. In the “values” section of the query window, the operator-selects “land,” and in the “criteria” section of the query window, the operator selects “hide.” The operator then presses the enter key on the key interface 18.

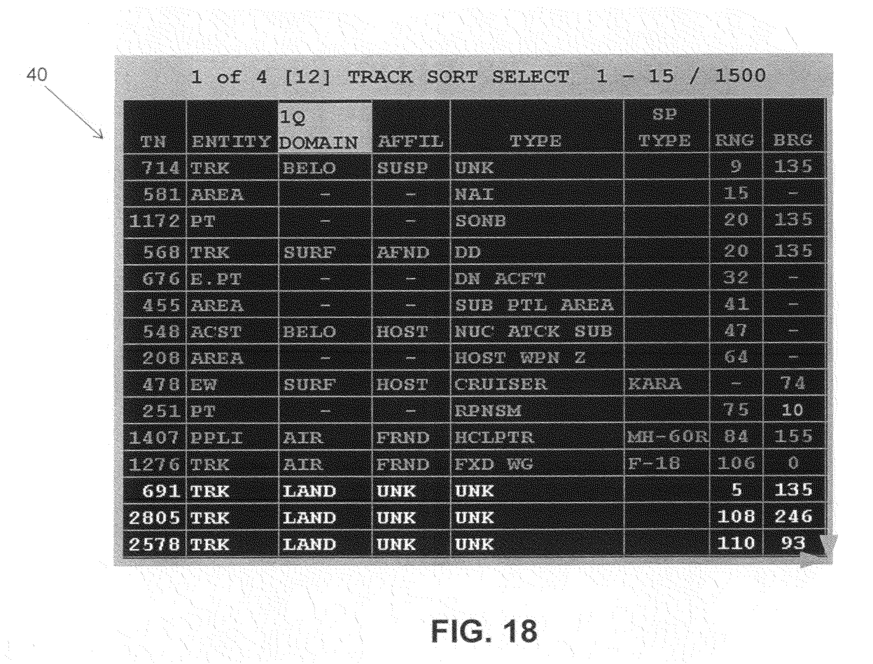

FIG. 18 shows the appearance of the TSS table 40 after the enter key is pressed. Notably, all land tracks have moved to the bottom of the table and are ghosted. The indicator “1Q” is displayed with the domain header to indicate that a first query has been performed.

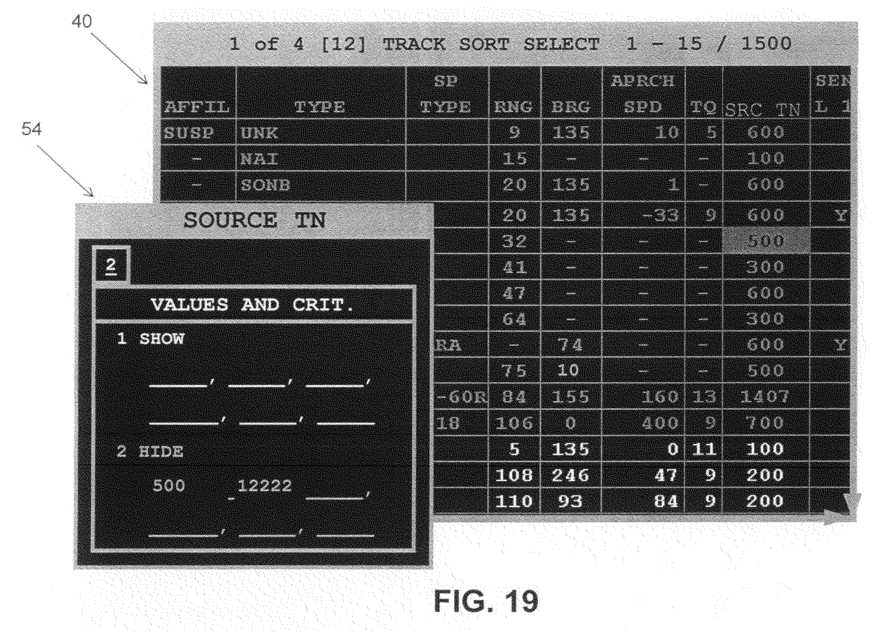

FIG. 19 shows the next steps of the task, which involve using the “filter” capability to hide transmissions from sources having source track numbers 500 and 12222. First, using the TSS table key layer, the operator arrows over to the source track number column of the TSS table 40 and presses the QRY key to cause the “source TN” query window 54 to appear over the TSS table. In the “hide” section of the query window, the operator fills in 500 and 12222 and presses the enter key on the TSS table key layer.

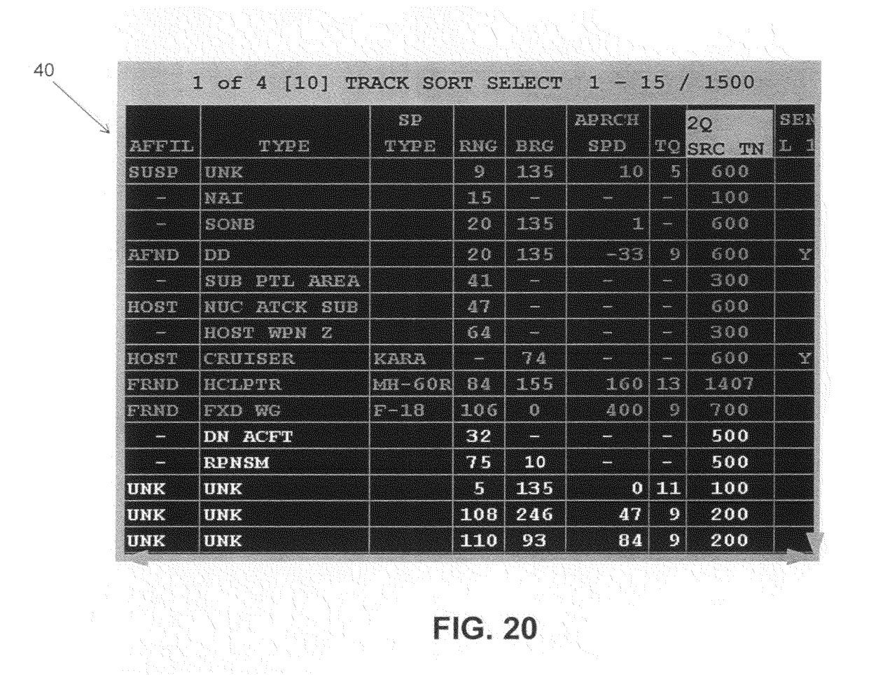

FIG. 20 shows the appearance of the TSS table 40 after the enter key is pressed. Notably, all tracks from the source track numbers 500 and 12222 (in this case, only tracks from source track number 500 are shown) have been moved to the bottom of the table (joining the land entities previously shown) and are ghosted. The indicator “2Q” is displayed with the source track number header to indicate that a second query has been performed.

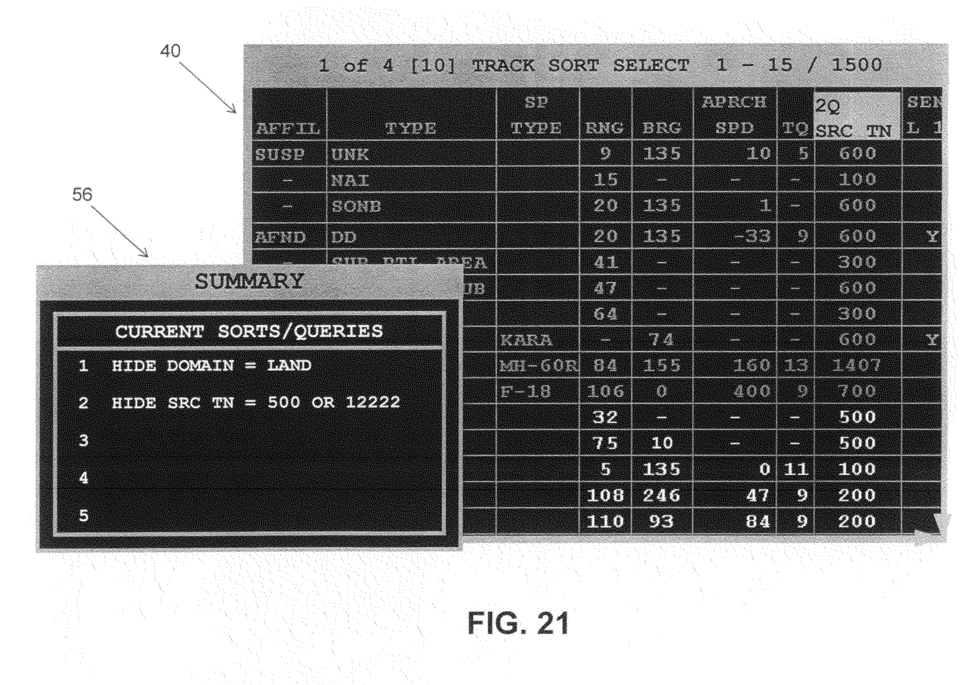

FIG. 21 shows a summary window 56 of all current sorts and queries. The summary window 56 may be viewed by pressing the VIEW SMY key (FIG. 4). The summary window confirms that the TSS table 40 has been configured to hide tracks from land domains and to hide tracks from sources having track numbers 500 or 12222.

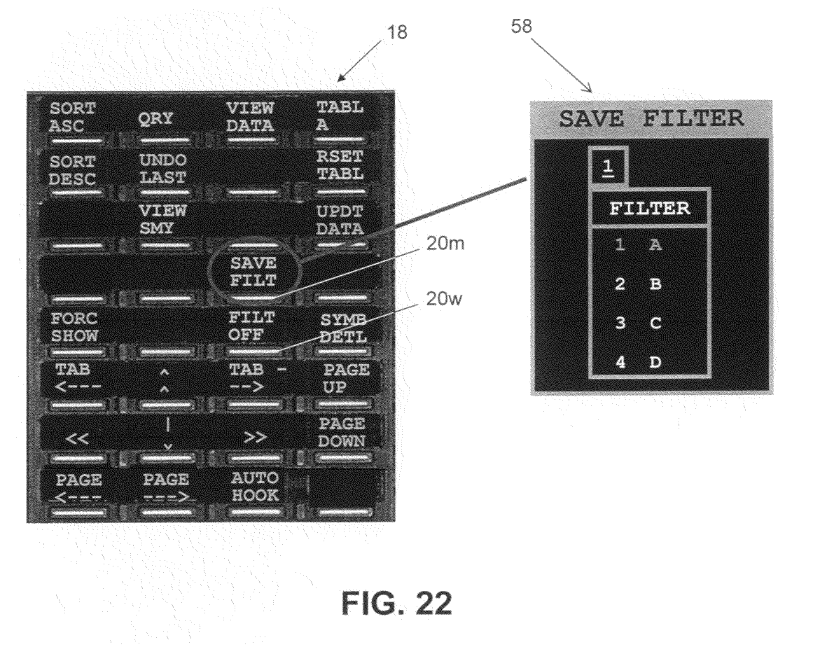

FIG. 22 highlights two keys on the TSS table key layer of the key interface 18 that may be used in connection with the “filter” capability of the TSS application. In particular, to save the current set of queries to a filter, the “SAVE FILT” key 20m may be pressed to open the save filter window 58. To save the filter as filter A, option A may be selected and the enter key may be pressed on the key interface 18 (the enter key is not shown on the key interface 18 of FIG. 22 because it is displayed after the window 58 is opened) to process the save and close the window. In this manner, the current set of queries can be simply activated and deactivated at any time, without having to repeat each of the steps set out in FIGS. 16-21. To activate the filter, the “FILT” key 20w, which is a round-robin key, may be pressed until “FILT A” is displayed.

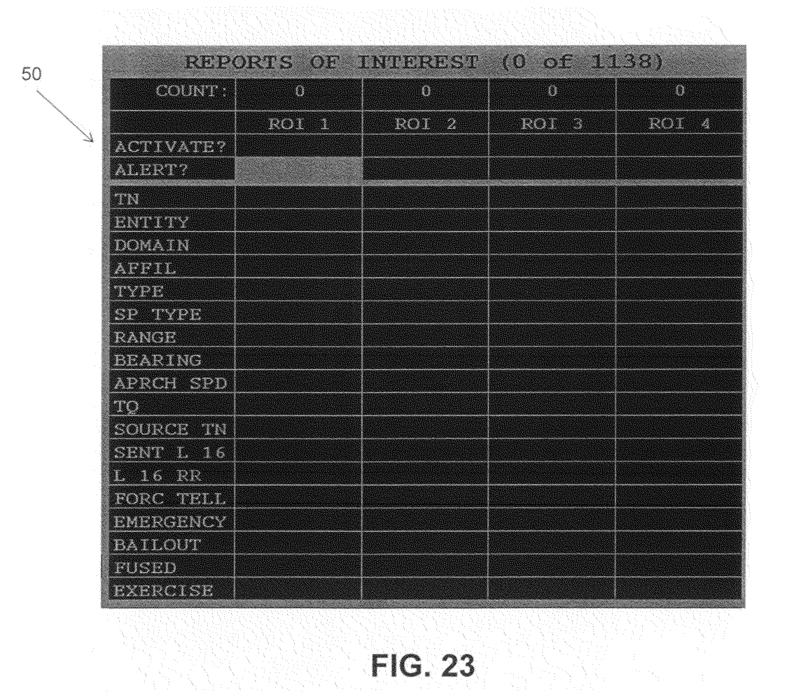

FIG. 23 shows the next step in the task commenced in FIG. 16. The summary window 56 of FIG. 21 confirmed that the TSS table 40 has been configured to hide tracks from land domains and to hide tracks from sources having source track numbers 500 or 12222. Thus, all tracks from land domains are currently filtered. However, as set out above, we do not want to filter land entity transmissions from source track number 500. Accordingly, we want to establish a report of interest to allow such land entity transmissions to bypass or override the previously set filter. To do so, we first close the TSS table 40 by pressing the “VIEW” round-robin key 20p (FIG. 7a), and then open the reports of interest definition window 50 by pressing the “DEF ROI” key 20q (FIG. 13).

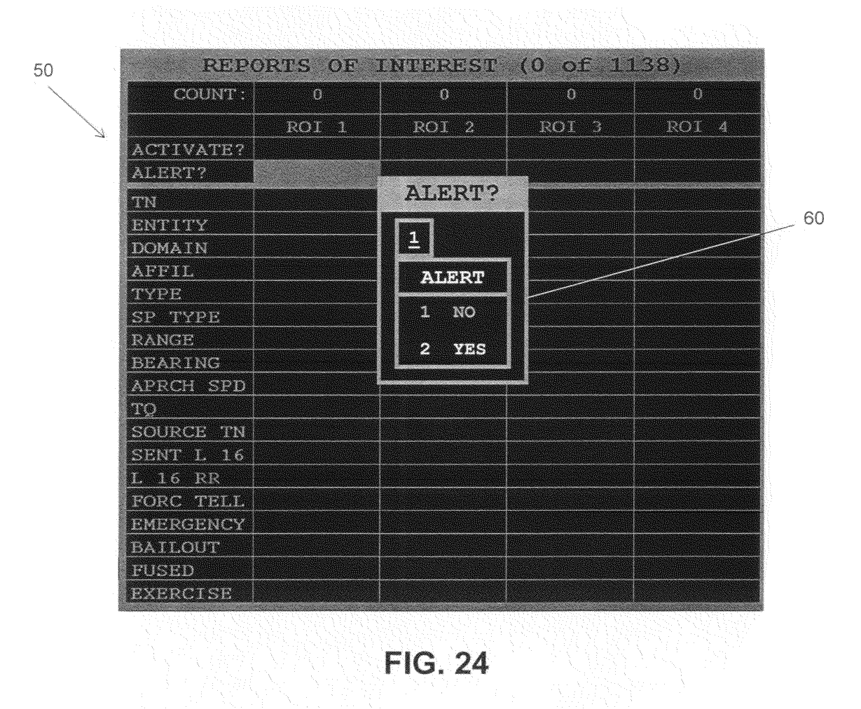

In this window, a field is provided to select whether or not alerts should be generated for the report of interest. In this case, we do not want to be alerted for each item. To specify “no,” the cursor is moved to the appropriate box and the “EDIT” key 20t (FIG. 15) is pressed. This causes an alert window 60 to open, as shown in FIG. 24. “No” is selected and the enter key is pressed to save the selection and close the window.

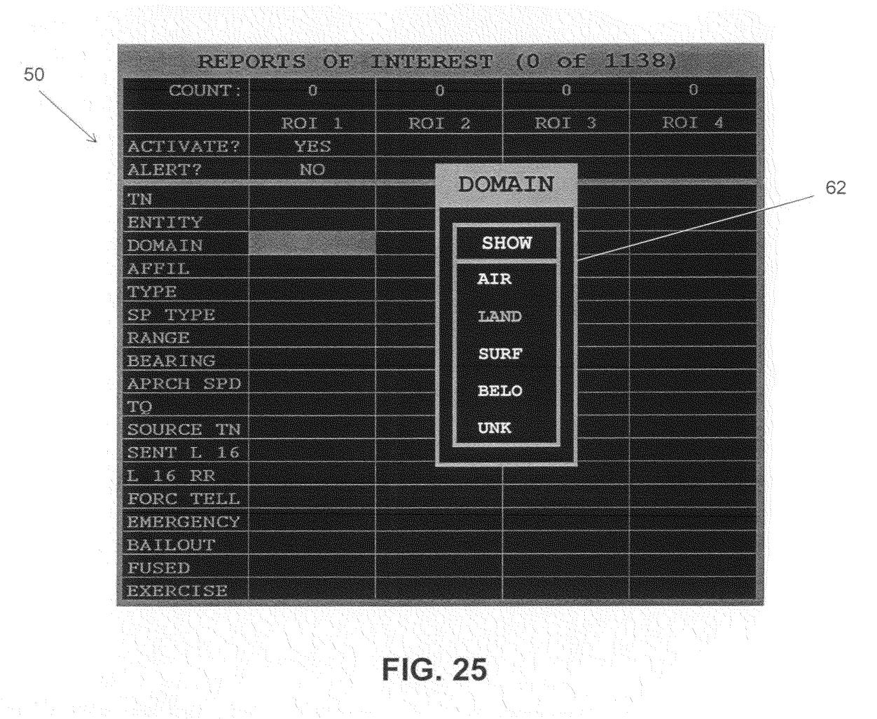

FIG. 25 shows the process for editing the domain criterion of the report of interest. In the reports of interest definition window 50, the cursor is moved to the domain row in the ROI 1 column, and the “EDIT” key (FIG. 15) is pressed. A “domain” sub-window 62 is opened, in which several options are displayed. The LAND option is selected, and the enter key is pressed to save the selection and close the sub-window 62.

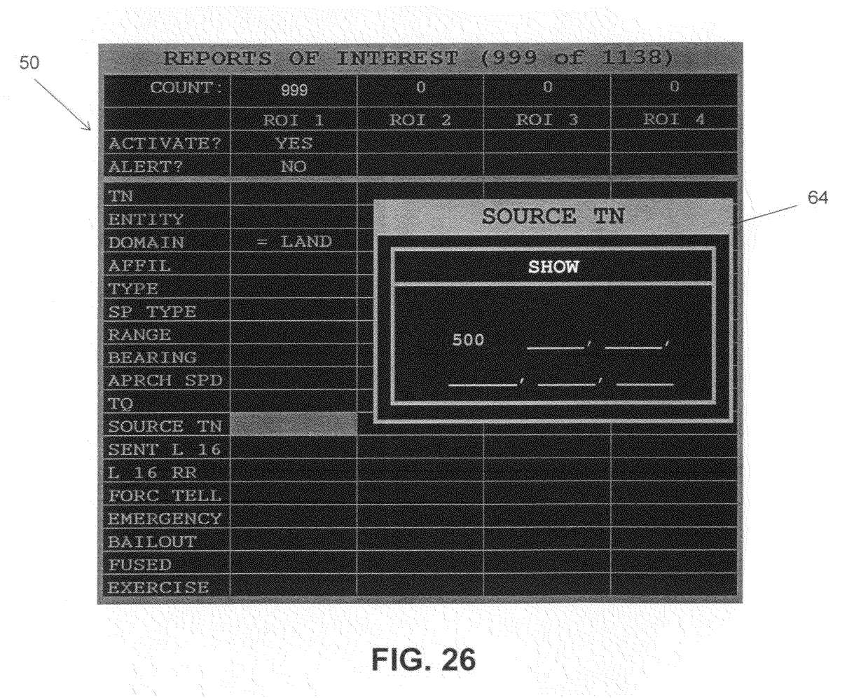

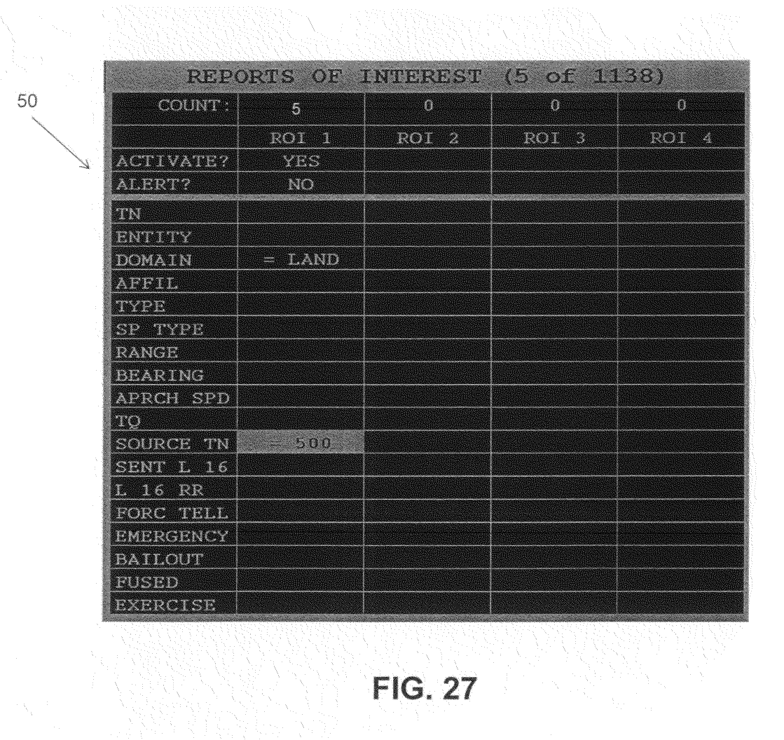

FIG. 26 shows the process for editing the source track number criterion of the report of interest. In the reports of interest definition window 50, the cursor is moved to the source TN row in the ROI 1 column, and the EDIT key is pressed. A source track number sub-window 64 is opened, and the desired number, “500,” is entered. The enter key is pressed to save the selection and close the sub-window 64. The edited report of interest is shown in FIG. 27.

The process for creating a report of interest to ensure that land entities sent by the source having source track number 500 are shown, and not filtered, is now complete. Accordingly, the “ENT” key 20s (FIG. 15) may be pressed to process the report of interest and close the window. The report of interest will be implemented immediately in the system.

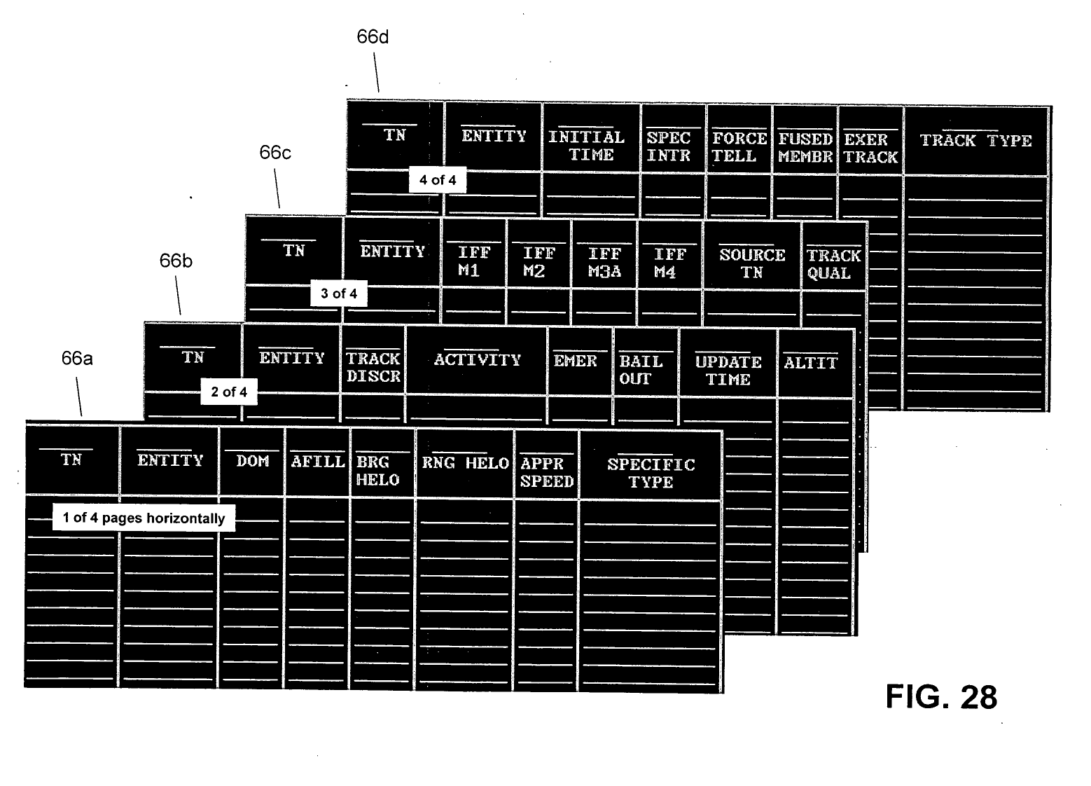

As discussed previously, the TSS table 40 shows only a portion of the data for displayed tracks. To view the additional columns listing attributes not shown on the first horizontal page of the display, an operator may scroll by page, as shown in FIG. 28. For reference, the track number and entity columns remain fixed, and are thus displayed for each horizontal page 66a-d.

It should be appreciated that the find, filtering, and reports of interest capabilities described herein may be used not only to reconfigure displayed data in tabular format, but also to reconfigure data displayed on a tactical plot. For example, tracks that are “filtered,” or otherwise given a lower priority status, may be ghosted in the plot or omitted from the plot. Tracks of particular interest, for example those that are given a higher priority status based on criteria defined in a report of interest, may be highlighted in some fashion on the plot, or may appear in the plot despite meeting one or more criteria for lower priority status.

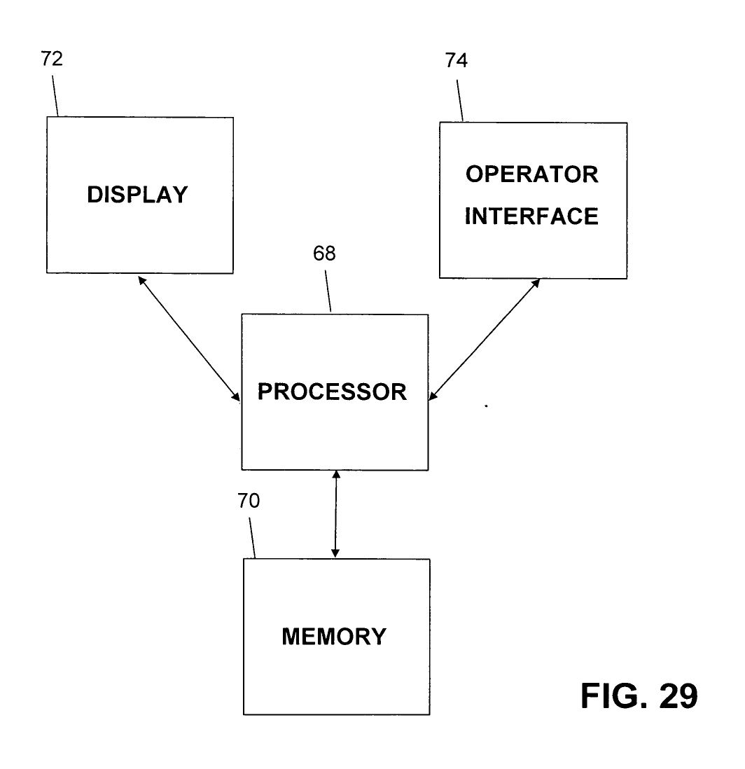

FIG. 29 shows an exemplary system for implementing methods described herein. The system comprises at least one processor 68, at least one memory 70, at least one display 72, and at least one operator interface 74. The operator interface 74 may comprise any of the interfaces described herein for accepting operator inputs, such as key interface 18. The display 72 may comprise any of the operator displays described herein, such as displays 16 and 36. Further, the display may optionally comprise an input interface (e.g., a touch screen). The processor 68 is operatively coupled to each of the operator interface 74 and the display 72. In particular, the processor may send data such as text or graphical information to be displayed, to the display 72 and/or the operator interface 74. Further, the processor 68 may receive data, such as selection, text, or numeric information, from the operator interface 74 and/or the display. The processor 68 is in turn operatively coupled to the memory 70. The memory may store instructions (e.g., in the form of a program) that, when executed by the processor 68, perform one or more functions or processes described herein. The memory 70 may receive information from the processor 68, such as entries into a database or operator specifications. The processor 68 may retrieve this received information or other information from the memory 70.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting.

What is claimed is:

1. A method for processing tactical data comprising acts of:
at least partially displaying a table comprising a list of tactical entities and respective attributes of said entities;
inputting information supplied by an operator concerning at least one of the attributes; and
reordering the list based on the operator-supplied information.

2. The method of claim 1, wherein the act of reordering comprises reordering the list such that entities of interest are displayed nearer to the top of the table.

3. The method of claim 1, wherein the act of reordering comprises reordering the list such that entities of lesser interest are suppressed.

4. The method of claim 1, further comprising an act of:
receiving data concerning the entities from multiple sensors and communications links.

5. The method of claim 1, further comprising an act of:
receiving data concerning the entities from a tactical data link.

6. The method of claim 5, further comprising an act of:
receiving data concerning the entities from a Link 16 tactical data link.

7. The method of claim 1, wherein:
the act of inputting comprises inputting first information supplied by the operator concerning a first criterion of a first one of the attributes and inputting second information supplied by the operator concerning a second criterion of a second one of the attributes; and
the act of reordering comprises reordering the list such that entities having both the first criterion of the first attribute and the second criterion of the second attribute are displayed nearer to the top of the table.

8. The method of claim 1, wherein the acts of inputting and displaying are performed at the same console.

9. The method of claim 1, wherein the acts of inputting and displaying are performed within the same aircraft.

10. The method of claim 1, further comprising steps of:
selecting an entity of interest in the list from the table;
inputting a command supplied by an operator concerning the entity; and
displaying the entity at the center of a tactical plot in response to the command.

12. At least one computer readable medium encoded with instructions that, when executed, perform the method of claim 1.

13. A method for processing tactical data comprising acts of:
providing a database of tactical entities and respective attributes of said entities;
inputting information supplied by an operator concerning at least one selected attribute;
displaying, on a tactical plot, a representation of an entity in the database; and
when said entity has the at least one selected attribute, providing an alert to the operator.

14. The method of claim 13, wherein the alert comprises an annotation displayed with the representation of the entity having the at least one selected attribute.

15. At least one computer readable medium encoded with instructions that, when executed, perform the method of claim 13.

16. A method for processing tactical data comprising acts of:
providing a database of tactical entities and respective attributes of said entities;
inputting first information supplied by an operator specifying at least one criterion of at least one first selected attribute, the first information defining information of interest to the operator;
inputting second information supplied by an operator specifying at least one criterion of at least one second selected attribute, the second information defining information of lesser interest to the operator;
processing the database of entities based on the first information and the second information to identify a sub-group of the entities wherein none of the entities included in the sub-group has the at least one criterion of the at least one second selected attribute unless said entity also has the at least one criterion of the at least one first selected attribute; and
displaying to the operator information pertaining only to entities within the sub-group.

17. The method of claim 16, wherein the act of displaying comprises at least partially displaying a table comprising a list of the sub-group of entities and respective attributes of said entities.

18. The method of claim 17, wherein the entities having the at least one criterion of the at least one first selected attribute are prioritized in the table.

19. The method of claim 16, wherein the act of displaying comprises displaying a tactical plot comprising representations only of entities within the sub-group.

20. At least one computer readable medium encoded with instructions that, when executed, perform the method of claim 16.

21. A system for processing tactical data, comprising:
at least one display;
at least one operator interface;
at least one processor; and
at least one computer readable medium encoded with instructions that, when executed by the at least one processor, perform a method comprising:
(A) at least partially displaying a table on the at least one display, wherein the table comprises a list of tactical entities and respective attributes of said entities;
(B) inputting information supplied by an operator via the at least one operator interface, wherein the operator-supplied information concerns at least one of the attributes; and
(C) reordering the list based on the operator-supplied information.

22. The system of claim 21, wherein (C) comprises reordering the list such that entities of interest are displayed nearer to the top of the table.

23. The system of claim 21, wherein (C) comprises reordering the list such that entities of lesser interest are suppressed.

24. The system of claim 21, further comprising:
a receiver, coupled to the processor, wherein the receiver is adapted to receive data concerning the entities from a tactical data link.

25. The system of claim 21, wherein the system is disposed within an aircraft.
